(19) United States
(12) Patent Application Publication
(10) Pub. No.: US 2024/0205569 A1
(43) Pub. Date: Jun. 20, 2024

(54) IMAGING DEVICE, ELECTRONIC DEVICE, AND LIGHT DETECTING METHOD

(71) Applicant: Sony Semiconductor Solutions Corporation, Kanagawa (JP)

(72) Inventors: Shinya Tanimura, Kanagawa (JP); Tomohiko Shibata, Kanagawa (JP)

(21) Appl. No.: 18/555,603

(22) PCT Filed: Feb. 18, 2022
(86) PCT No.: PCT/JP2022/006699

§ 371 Date: Oct. 16, 2023

(30) Foreign Application Priority Data
Jun. 1, 2021 (JP) 2021-092525

(51) Int. Cl. H04N 25/778; G06V 20/58; H04N 23/71; H04N 25/78

(52) U.S. Cl. CPC H04N 25/778; G06V 20/58; H04N 23/71; H04N 25/78

(57) ABSTRACT

[Problem] To provide an imaging device that can detect a rapid luminance change.

[Solution] An imaging device according to an embodiment of the present disclosure includes: a photoelectric conversion circuit that generates a pixel signal corresponding to a luminance of incident light; and a reading circuit that reads the pixel signal from the photoelectric conversion circuit. The reading circuit includes: a first amplifier circuit that reads the pixel signal in a first period; a second amplifier circuit that reads the pixel signal in a second period subsequent to the first period; an adding circuit that adds a first output signal of the first amplifier circuit and a second output signal of the second amplifier circuit; and a comparator circuit that detects a change of the luminance on the basis of a third output signal of the adding circuit.

### TECHNICAL FIELD

The present disclosure relates to an imaging device, an electronic device, and a light detecting method.

### BACKGROUND ART

As an event-driven imaging device, an asynchronous imaging device called a DVS (Dynamic Vision Sensor) is known. Only when an event (e.g., a movement) occurs in a scene, an asynchronous imaging device acquires data on a part where a luminance level is changed by the event. Therefore, an asynchronous imaging device can acquire image data at higher speeds than an ordinary synchronous imaging device that unnecessarily acquires all the pieces of image data at a fixed frame rate.

### CITATION LIST

### Patent Literature

[PTL 1] JP 2018-148553A
[PTL 2] Japanese Translation of PCT Application No. 2015-501936

### SUMMARY

### Technical Problem

In a DVS imaging device, a pixel having detected a luminance change is reset. In a period during which the pixel is reset, a luminance change cannot be detected, resulting in a so-called dead-time period. Thus, information about a luminance change may be lost in an environment where the luminance of incident light changes quickly.

The present disclosure provides an imaging device, an electronic device, and a light detecting method, which can detect a quick luminance change.

### Solution to Problem

An imaging device according to an embodiment of the present disclosure includes: a photoelectric conversion circuit that generates a pixel signal corresponding to a luminance of incident light; and a reading circuit that reads the pixel signal from the photoelectric conversion circuit. The reading circuit includes: a first amplifier circuit that reads the pixel signal in a first period; a second amplifier circuit that reads the pixel signal in a second period subsequent to the first period; an adding circuit that adds a first output signal of the first amplifier circuit and a second output signal of the second amplifier circuit; and a comparator circuit that detects a change of the luminance on the basis of a third output signal of the adding circuit.

The reading circuit may be disposed between the second amplifier circuit and the adding circuit and may further include a sampling hold circuit that temporarily holds the second output signal.

The second amplifier circuit may have a circuit configuration identical to the circuit configuration of the first amplifier circuit.

The first amplifier circuit may include a first P-type transistor, a first N-type transistor connected in series with the first P-type transistor, and a first switch disposed between the gate of the first P-type transistor and the source of the first P-type transistor,

the second amplifier circuit may include a second P-type transistor, a second N-type transistor connected in series with the second P-type transistor, and a second switch disposed between the gate of the second P-type transistor and the source of the second P-type transistor,

in the first period, the first switch may be placed in an off-state and the second switch may be placed in an on-state, and

in the second period, the first switch may be placed in an on-state and the second switch may be placed in an off-state.

The sampling hold circuit may include a third switch disposed between the second amplifier circuit and the adding circuit, and a capacitor with one end connected to the third switch and the adding circuit and the other end grounded, and the third switch may be placed in an off-state in the first period and may be placed in an on-state in the second period.

The imaging device may further include a pixel array part including a plurality of pixels arranged in a two-dimensional array,

wherein each of the plurality of pixels may include the photoelectric conversion circuit and the reading circuit.

The imaging device may be configured with a P-type transistor or an N-type transistor that is driven on the basis of a reset signal with a signal level changing at the timing of switching of the first switch, the second switch, and the third switch from the first period to the second period.

The first switch, the second switch, and the third switch may be each configured with a third P-type transistor, and

the imaging device may further include an inverter that inverts the signal level of the reset signal inputted to the second switch.

The first switch and the third switch may be each configured with a third P-type transistor, and

the second switch may be configured with a third N-type transistor.

The sampling hold circuit may include a third switch disposed between the second amplifier circuit and the adding circuit, and a capacitor with one end connected to the third switch and the adding circuit and the grounded other end, and

the third switch may be placed in an on-state in the first period and the second period.

The imaging device may further include a pixel logic circuit that drives the photoelectric conversion circuit and the reading circuit.

The pixel logic circuit may generate the reset signal.

The second period may be the reset period of the first amplifier circuit, and the length of the reset period may be fixed.

The second period may have a length that is variable according to the detection result of the comparator circuit.

The comparator circuit may include:

a first comparator that outputs the result of a comparison of the third output signal with a predetermined upper-limit threshold value; and

a second comparator that outputs the result of a comparison of the third output signal with a predetermined lower-limit threshold value.

An electronic device according to an embodiment of the present disclosure includes an imaging device including: a photoelectric conversion circuit that generates a pixel signal corresponding to a luminance of incident light; a first amplifier circuit that reads the pixel signal in a first period; a second amplifier circuit that reads the pixel signal in a second period subsequent to the first period; an adding circuit that adds a first output signal of the first amplifier circuit and a second output signal of the second amplifier circuit; and a comparator circuit that detects a change of the luminance on the basis of a third output signal of the adding circuit.

A light detecting method according to an embodiment of the present disclosure includes:

generating a pixel signal corresponding to a luminance of incident light;

reading the pixel signal in a first period by a first amplifier circuit;

reading the pixel signal in a second period subsequent to the first period by a second amplifier circuit different from the first amplifier circuit;

adding a first output signal of the first amplifier circuit and a second output signal of the second amplifier circuit by an adding circuit; and

detecting a change of the luminance on the basis of a third output signal of the adding circuit.

### BRIEF DESCRIPTION OF DRAWINGS

FIG. 1 is a block diagram illustrating the configuration of an imaging device according to a first embodiment.

FIG. 2 is a block diagram illustrating the configuration of a pixels 11.

FIG. 3 illustrates the configuration of a photodetector circuit according to the first embodiment.

FIG. 4 is a timing chart for explaining the operation of the photodetector circuit according to the first embodiment.

FIG. 5 is a timing chart of a reset signal inputted to each switch of the photodetector circuit.

FIG. 6 illustrates the configuration of a photodetector circuit according to a second embodiment.

FIG. 7 illustrates the configuration of a photodetector circuit according to a third embodiment.

FIG. 8 is a timing chart for explaining the operation of the photodetector circuit according to the third embodiment.

FIG. 9 illustrates the configuration of a photodetector circuit according to a fourth embodiment.

FIG. 10 illustrates an example of the configuration of an electronic device according to a fifth embodiment.

FIG. 11 is a block diagram illustrating an example of a schematic configuration of a vehicle control system.

FIG. 12 is an explanatory drawing illustrating an example of the installation positions of a vehicle exterior information detection unit and imaging units.

### DESCRIPTION OF EMBODIMENTS

### First Embodiment

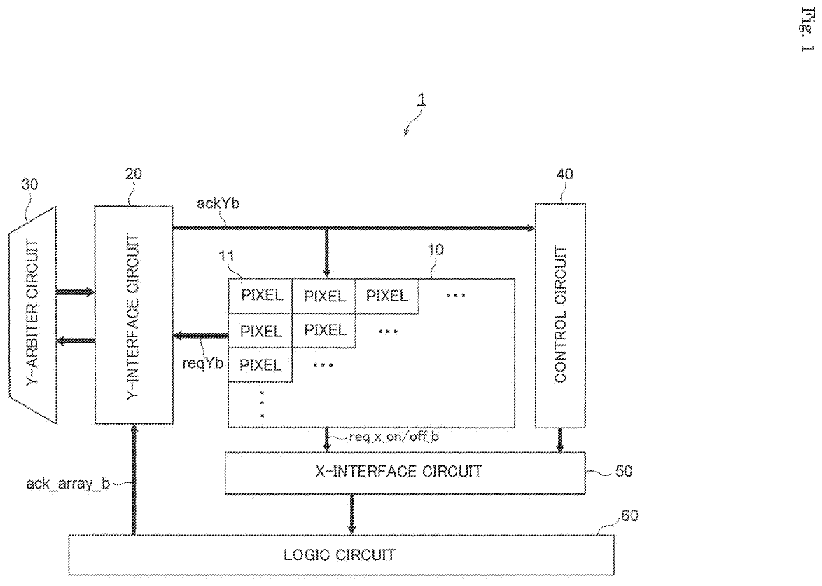

FIG. 1 is a block diagram illustrating the configuration of an imaging device according to a first embodiment. An imaging device 1 in FIG. 1 includes a pixel array part 10, a Y-interface circuit 20, a Y-arbiter circuit 30, a control circuit 40, an X-interface circuit 50, and a logic circuit 60.

In the pixel array part 10, a plurality of pixels 11 are arranged in a two-dimensional array. Each of the pixels 11 detects a change of the luminance of incident light (in other words, the illuminance of received light). The pixel 11 having detected a luminance change outputs a detection signal reqYb to the Y-interface circuit 20.

The Y-interface circuit 20 temporarily holds the detection signal reqYb and then outputs the signal to the Y-arbiter circuit 30.

The Y-arbiter circuit 30 returns an acknowledge signal ack Yb that indicates the reception of the detection signal reqYb. The acknowledge signal ack Yb is transmitted to all the pixels of a row, to which the pixel 11 having outputted the detection signal reqYb belongs, and the control circuit 40 through the Y-interface circuit 20. If a plurality of detection signals reqYb are received in the Y-arbiter circuit 30, the acknowledge signal ackYb is returned to the first pixel 11 having detected the detection signal reqYb.

The fired pixel 11 having received the acknowledge signal ack Yb starts a resetting operation. Moreover, the fired pixel 11 outputs information req_x_on/off_b, which indicates the contents of a luminance change, to the X-interface circuit 50 concurrently with the resetting operation. The information req_x_on/off_b is acquired by the logic circuit 60 through the X-interface circuit 50, the acquisition being triggered by the reception of the signal from the control circuit 40. The information req_x_on/off_b is held in the X-interface circuit 50 until the signal from the control circuit 40 is received.

Thereafter, the control circuit 40 outputs a control signal for providing an instruction to cancel the resetting operation, to the X-interface circuit 50 when the acknowledge signal ackYb is received. The control signal is received by the logic circuit 60 through the X-interface circuit 50.

When receiving the information req_x_on/off_b and the control signal, the logic circuit 60 outputs a reset cancellation signal ack_array_b to the Y-interface circuit 20. The reset cancellation signal ack_array_b changes the signal level of the acknowledge signal ackYb. Thus, the fired pixel 11 cancels the resetting operation.

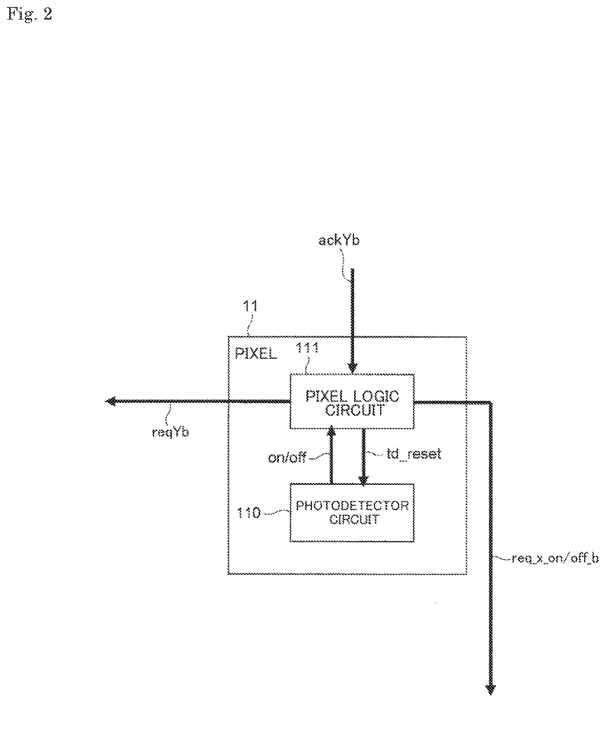

FIG. 2 is a block diagram illustrating the configuration of the pixel 11. As illustrated in FIG. 2, the pixel 11 includes a photodetector circuit 110 and a pixel logic circuit 111. The photodetector circuit 110 and the pixel logic circuit 111 may be disposed on a semiconductor substrate (semiconductor chip) or may be separately disposed on two stacked semiconductor substrates.

The photodetector circuit 110 outputs a determination signal on/off, which indicates the result of determination on whether the luminance of incident light has changed, to the pixel logic circuit 111.

If the determination signal on/off indicates the occurrence of a luminance change, the pixel logic circuit 111 generates the detection signal reqYb and outputs the signal to the Y-interface circuit 20. In this case, the pixel logic circuit 111 receives the acknowledge signal ackYb. The pixel logic circuit 111 then changes the signal level of a reset signal td_reset from a low level to a high level and transmits the signal to the photodetector circuit 110. The pixel logic circuit 111 outputs the information req_x_on/off_b to the X-interface circuit 50 concurrently with the transmission of the photodetector circuit 110.

The photodetector circuit 110 starts a resetting operation, which is triggered by a change of the signal level of the reset signal td_reset. Thereafter, when the signal level of the acknowledge signal ackYb changes, the pixel logic circuit 111 changes the signal level of the reset signal td_reset from the low level to the high level. The photodetector circuit 110 terminates the resetting operation in response to the change of the signal level.

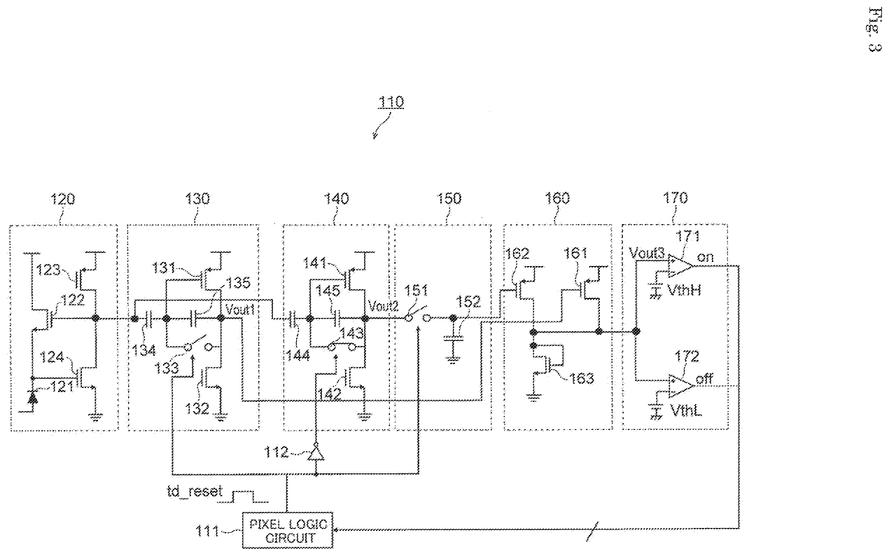

FIG. 3 illustrates the configuration of the photodetector circuit 110 according to the first embodiment. As illustrated in FIG. 3, the photodetector circuit 110 includes a photoelectric conversion circuit 120, a first amplifier circuit 130, a second amplifier circuit 140, a sampling hold circuit 150, an adding circuit 160, and a comparator circuit 170. The circuits will be described below.

The photoelectric conversion circuit 120 includes a photodiode 121, an N-type transistor 122, a P-type transistor 123, and an N-type transistor 124. The N-type transistor 122 and the N-type transistor 124 are each configured with, for example, an N-channel MOSFET, and the P-type transistor 123 is configured with, for example, a P-channel MOSFET.

A negative voltage (e.g., 1.2 V) is applied to the anode of the photodiode 121, and the cathode of the photodiode 121 is connected to the source of the N-type transistor 122 and the gate of the N-type transistor 124. The photodiode 121 photoelectrically converts incident light.

The N-type transistor 122 is connected to the photodiode 121 and the power supply. The P-type transistor 123 and the N-type transistor 124 are connected in series between the power supply and the ground. The drains of the P-type transistor 123 and the N-type transistor 124 are connected to the gate of the N-type transistor 122.

In the photoelectric conversion circuit 120 configured thus, when a predetermined bias voltage is applied to the gate of the P-type transistor 123, the P-type transistor 123 supplies a constant voltage to the N-type transistor 124. The gate potential of the N-type transistor 124 is determined by a current supplied from the P-type transistor 123. The gate potential of the N-type transistor 122 is determined by the output current of the photodiode 121. Therefore, the photoelectric conversion circuit 120 converts a current photoelectrically converted by the photodiode 121, into a pixel signal of the logarithm, and outputs the pixel signal. The amount of charge of the pixel signal corresponds to the luminance of incident light.

The first amplifier circuit 130 includes a first P-type transistor 131, a first N-type transistor 132, a first switch 133, a capacitor 134, and a capacitor 135. The first P-type transistor 131 and the first N-type transistor 132 are connected in series between the power supply and the ground. The first switch 133 and the capacitor 135 are connected in parallel between the gate and the drain of the first P-type transistor 131. In the present embodiment, the first switch 133 is configured with a P-channel MOSFET that is turned on or off according to the signal level of the reset signal td_reset from the pixel logic circuit 111. The capacitor 134 is connected between a buffer circuit (not illustrated) and the gate of the first P-type transistor 131 and is connected in series with the capacitor 135. The buffer circuit includes two P-type transistors that are disposed between the photoelectric conversion circuit 120 and the first amplifier circuit 130 and are connected in series. The capacitor 134 is connected to the drains of the P-type transistors.

When the first switch 133 is placed in an off-state, the first amplifier circuit 130 outputs a signal obtained by amplifying the pixel signal generated by the photoelectric conversion circuit 120. In contrast, when the first switch 133 is placed in an on-state, the first amplifier circuit 130 is reset.

The second amplifier circuit 140 is parallel with the first amplifier circuit 130 with respect to the photoelectric conversion circuit 120 and includes a second P-type transistor 141, a second N-type transistor 142, a second switch 143, a capacitor 144, and a capacitor 145. The second amplifier circuit 140 has the same circuit configuration as the first amplifier circuit 130, and thus a detailed description thereof is omitted.

In the present embodiment, however, an inverter 112 is disposed between the second amplifier circuit 140 and the pixel logic circuit 111. The inverter 112 inverts the reset signal td_reset from the pixel logic circuit 111 and inputs the signal to the second switch 143. Like the first switch 133, the second switch 143 is configured with a P-channel MOSFET that is turned on or off according to the signal level of the reset signal td_reset. Thus, an operation is inverted between the first amplifier circuit 130 and the second amplifier circuit 140. Specifically, when the first amplifier circuit 130 is driven, the second amplifier circuit 140 is reset. Thereafter, when the first amplifier circuit 130 is reset, the second amplifier circuit 140 is driven.

The sampling hold circuit 150 includes a third switch 151 and a capacitor 152. The third switch 151 is disposed between the second amplifier circuit 140 and the adding circuit 160. One end of the capacitor 152 is connected to the third switch 151 and the adding circuit 160, and the other end of the capacitor 152 is grounded.

Like the first switch 133, the third switch 151 is configured with a P-channel MOSFET that is turned on or off according to the signal level of the reset signal td_reset. When the third switch 151 is turned off, the output signal of the second amplifier circuit 140 is temporarily held by the capacitor 152. When the third switch is turned on, the output signal of the second amplifier circuit 140 is inputted as it is to the adding circuit 160.

The adding circuit 160 includes a P-type transistor 161, a P-type transistor 162, and an N-type transistor 163. The P-type transistor 161 and the P-type transistor 162 are connected in parallel. The N-type transistor 163 is connected in series with the P-type transistor 161. The drain and the gate of the N-type transistor 163 are short-circuited.

The output signal (first output signal) of the first amplifier circuit 130 is inputted to the gate of the P-type transistor 161. The output signal (second output signal) of the second amplifier circuit 140 is inputted to the gate of the P-type transistor 162 through the sampling hold circuit 150. The source of the P-type transistor 161 and the source of the P-type transistor 162 are connected to each other. Thus, a signal obtained by adding the two output signals is outputted from the adding circuit 160.

The comparator circuit 170 includes a first comparator 171 and a second comparator 172. The first comparator 171 compares the output signal (third output signal) of the adding circuit 160 with a predetermined upper limit threshold value VthH. The first comparator 171 then outputs, to the pixel logic circuit 111, a determination signal on indicating whether the output signal of the adding circuit 160 has exceeded the upper-limit threshold value VthH.

The second comparator 172 compares the output signal (third output signal) of the adding circuit 160 with a predetermined lower-limit threshold value VthL. The second comparator 172 then outputs, to the pixel logic circuit 111, a determination signal off indicating whether the output signal of the adding circuit 160 has fallen below the lower-limit threshold value VthL.

The comparator circuit 170 determines whether the luminance of incident light has changed or not, on the basis of the result of a comparison of the output signal of the adding circuit 160 with the upper-limit threshold value VthH and the lower-limit threshold value VthL.

In the photodetector circuit 110, the circuits other than the photoelectric conversion circuit 120 (the first amplifier circuit 130 to the comparator circuit 170) constitute a reading circuit for reading a pixel signal from the photoelectric conversion circuit 120. The photoelectric conversion circuit 120 and the reading circuit may be disposed on a semiconductor substrate (semiconductor chip) or may be separately disposed on two stacked semiconductor substrates.

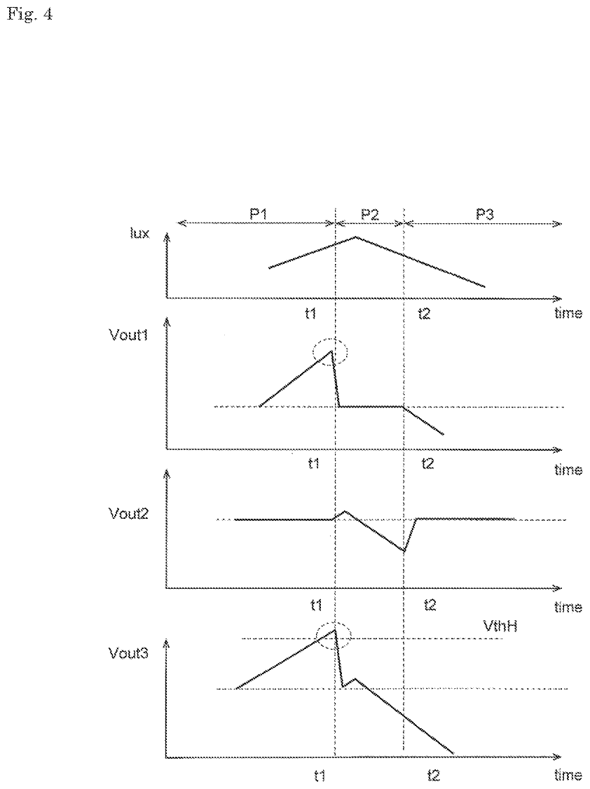

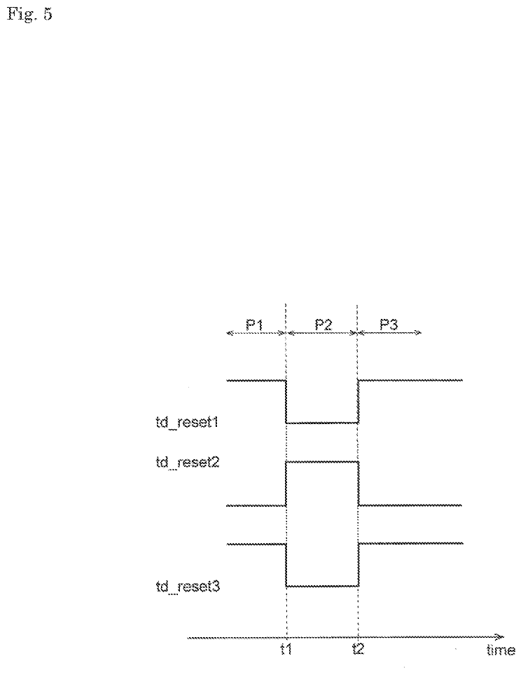

Referring to FIGS. 4 and 5, an operation of the imaging device 1 according to the present embodiment will be described below. Hereinafter, an operation for detecting a luminance change of incident light by the photodetector circuit 110 will be described.

FIG. 4 is a timing chart for explaining the operation of the photodetector circuit 110 according to the first embodiment. FIG. 4 shows an example of changes of a luminance lux of incident light, an output voltage (first output signal) Vout1 of the first amplifier circuit 130, an output voltage (second output signal) Vout2 of the second amplifier circuit 140, and an output voltage (third output signal) Vout3 of the adding circuit 160. In other words, the output voltage Vout2 is the output voltage of the sampling hold circuit 150.

FIG. 5 is a timing chart of the reset signal td_reset inputted to each switch of the photodetector circuit 110. In FIG. 5, a reset signal td_reset1 is inputted to the first switch 133, a reset signal td_reset2 is inputted to the second switch 143, and a reset signal td_reset3 is inputted to the third switch 151.

As shown in FIG. 5, in a period P1 (first period) before the photodetector circuit 110 is reset, the reset signal td_reset1 and the reset signal td_reset3 are set at a high level, whereas the reset signal td_reset2 is set at a low level. Thus, the first switch 133 and the third switch 151 are placed in an off-state and the second switch 143 is placed in an on-state. This brings the first amplifier circuit 130 into a driven state to read a pixel signal corresponding to the luminance Lux of incident light and brings the second amplifier circuit 140 into a reset state where the pixel signal is not read.

In the period P1, when the luminance Lux changes and the output voltage Vout3 of the adding circuit 160 exceeds the upper-limit threshold value VthH, the output level of the first comparator 171 changes. Accordingly, the pixel logic circuit 111 changes the signal level of each reset signal. Thus, as shown in FIG. 5, the reset signal td_reset1 and the reset signal td_reset3 change from the low level to the high level, whereas the reset signal td_reset2 changes from the high level to the low level. This switches the first switch 133 and the third switch 151 from an off-state to an on-state and switches the second switch 143 from an on-state to an off-state.

Consequently, in a reset (dead-time) period P2 (second period) subsequent to the period P1, the first amplifier circuit 130 is reset and the second amplifier circuit 140 is driven. Thus, in the reset period P2, a change of the luminance Lux is read by the second amplifier circuit 140.

The length of the reset period P2 is preset. At the end of the reset period P2, the pixel logic circuit 111 returns the signal level of each reset signal to the same state as the period P1. Thus, as illustrated in FIG. 5, the reset signal td_reset1 and the reset signal td_reset3 return from the high level to the low level, whereas the reset signal td_reset2 returns from the low level to the high level. Hence, in a period P3 after the reset, the first switch 133 and the third switch 151 return from an on-state to an off-state, whereas the second switch 143 returns from an off-state to an on-state. In the period P3, the third switch 151 is placed in an off-state, so that the output signal (luminance change information) of the second amplifier circuit 140 is held after being read in the reset period P2, and then the output signal is added to the output signal of the first amplifier circuit 130 by the adding circuit 160. In short, in the period P1 and the period P3, an addition signal of the output signal of the sampling hold circuit 150 with a held potential and the output signal of the first amplifier circuit 130 is inputted to the comparator circuit 170.

According to the present embodiment, in the reset period P2 during which the first amplifier circuit 130 is reset, the second amplifier circuit 140 reads the pixel signal from the photoelectric conversion circuit 120. Thus, a luminance change can be detected even in the reset period P2 during which a luminance change of incident light has been conventionally undetectable. This can detect a rapid luminance change. Hence, reading can be performed without losing luminance change information, thereby seamlessly detecting a luminance change. Therefore, the technique of the present disclosure contributes to the speedup of the operation of the imaging device 1.

In the present embodiment, the first switch 133, the second switch 143, and the third switch 151 are all configured with P-type transistors. This can suppress the influence of the noise of feedthrough or the like.

In the present embodiment, by using the inverter 112, the first switch 133, the second switch 143, and the third switch 151 are controlled by a single kind of reset signal. The method of controlling the switches is not limited thereto. For example, the pixel logic circuit 111 may generate two kinds of reset signal as inverted signals, control the first switch 133 and the third switch 151 in response to one of the reset signals, and control the second switch 143 in response to the other reset signal. Also in this case, a luminance change of incident light can be detected in the reset period P2.

### Second Embodiment

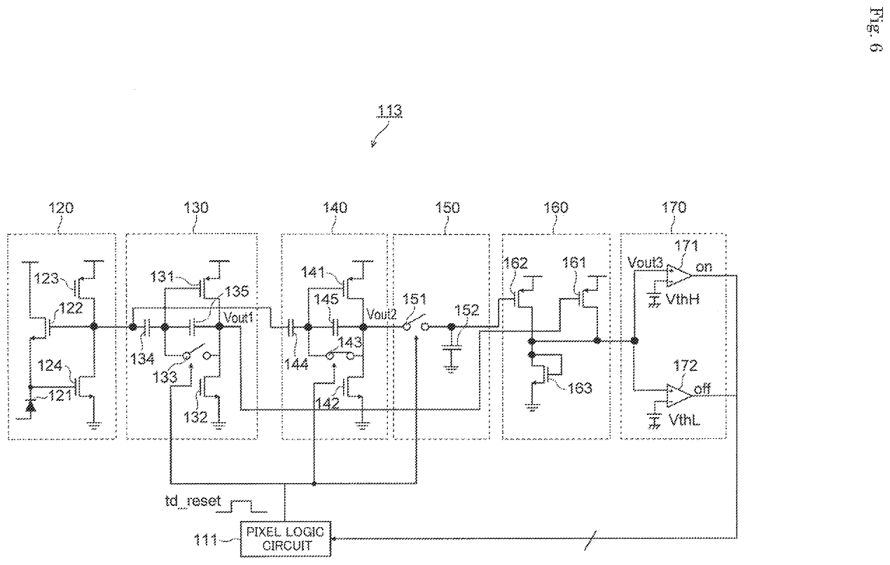

A second embodiment will be described below. The second embodiment is different from the first embodiment in the configuration of a photodetector circuit. Referring to FIG. 6, the configuration of the photodetector circuit according to the second embodiment will be described below.

FIG. 6 illustrates the configuration of the photodetector circuit according to the second embodiment. The same constituent elements as those of the first embodiment are indicated by the same reference numerals, and detailed descriptions thereof are omitted.

In a photodetector circuit 113 according to the present embodiment, a first switch 133 and a third switch 151 are both P-type transistors, whereas a second switch 143 is an N-type transistor. The on/off operations of the first switch 133 and the third switch 151 are inverted from the on/off operation of the second switch 143.

Thus, in the present embodiment, two kinds of transistors of different conductivity types are applied to each third switch 151 in response to an on/off operation. This can control the switches in response to a reset signal td_reset without providing the inverter 112 described in the first embodiment.

According to the present embodiment, the inverter 112 is not necessary. This can reduce the area of the photodetector circuit 113.

### Third Embodiment

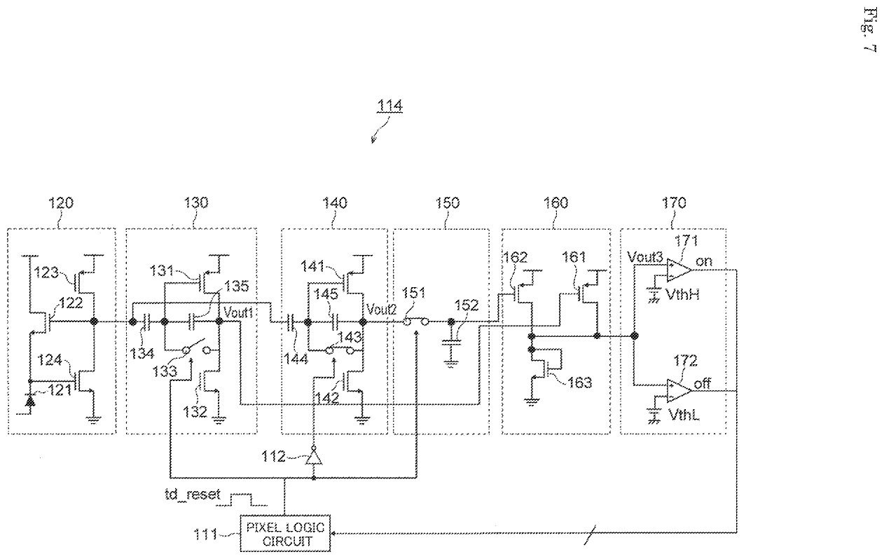

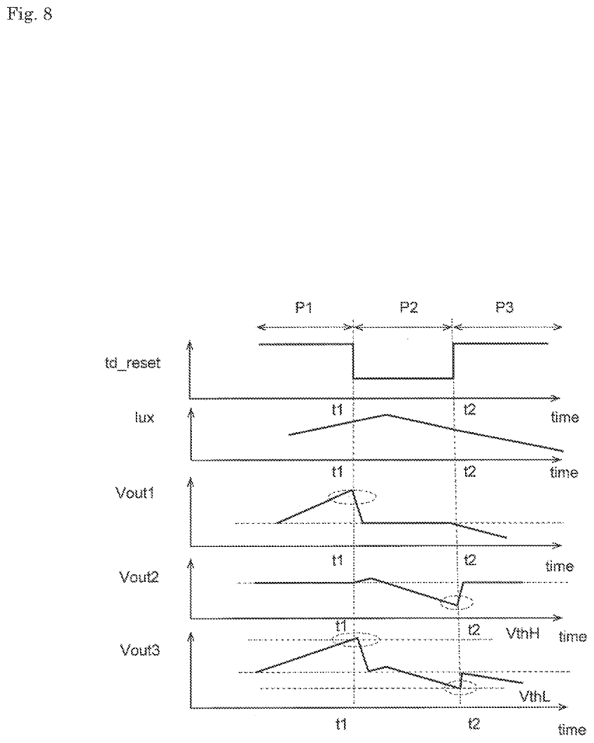

A third embodiment will be described below. The third embodiment is different from the first embodiment in the configuration of a photodetector circuit. Referring to FIGS. 7 and 8, the photodetector circuit according to the third embodiment will be described below.

FIG. 7 illustrates the configuration of the photodetector circuit according to the third embodiment. The same constituent elements as those of the first embodiment are indicated by the same reference numerals, and detailed descriptions thereof are omitted. In a photodetector circuit 114 according to the present embodiment, a first switch 133, a second switch 143, and a third switch 151 are configured with P-type transistors as in the first embodiment, though the third switch 151 is always placed in an on-state. Thus, a sampling hold circuit 150 is substantially inoperative. Specifically, the second output signal of a second amplifier circuit 140 is inputted to an adding circuit 160 without being held by the sampling hold circuit 150.

FIG. 8 is a timing chart for explaining the operation of the photodetector circuit 114 according to the third embodiment. As shown in FIG. 8, in a period P1, a reset signal td_reset is set at a high level and thus the first switch 133 is placed in an off-state. The second switch 143 is placed in an on-state on the basis of the reset signal td_reset inverted by an inverter 112. This brings a first amplifier circuit 130 into a driven state and brings the second amplifier circuit 140 into a reset state.

In the period P1, when the luminance Lux changes and the output voltage Vout3 of the adding circuit 160 exceeds the upper-limit threshold value VthH, the output level of the first comparator 171 changes. Accordingly, a pixel logic circuit 111 changes the reset signal td_reset from a low level to a high level, so that the first switch 133 is switched from an off-state to an on state and the second switch 143 is switched from an on-state to an off-state.

Consequently, in a reset period P2, the first amplifier circuit 130 is reset and the second amplifier circuit 140 is driven. In the first embodiment, the length of the reset period P2 is fixed, whereas in the present embodiment, the reset period P2 continues until a change of the luminance Lux is detected by the comparator circuit 170. In other words, the reset period P2 is variable in the comparator circuit 170 depending upon the result of detection.

In the reset period P2, when the output voltage Vout3 of the adding circuit 160 falls below a lower-limit threshold value VthL, the output level of a second comparator 172 changes. Accordingly, the pixel logic circuit 111 changes the reset signal td_reset from the high level to the low level. Thus, in a period P3, the first switch 133 returns from an on-state to an off-state and the second switch 143 returns from an off-state to an on-state.

According to the present embodiment, luminance changes of incident light are alternately read by the first amplifier circuit 130 and the second amplifier circuit 140 in a continuous manner. Thus, even if the function of the sampling hold circuit 150 is stopped, a rapid luminance change can be detected.

Moreover, in the present embodiment, the second output signal of the second amplifier circuit 140 is inputted to the adding circuit 160 without being held by the sampling hold circuit 150. This can eliminate a reading error caused by channel charge injection of the sampling hold circuit 150.

### Fourth Embodiment

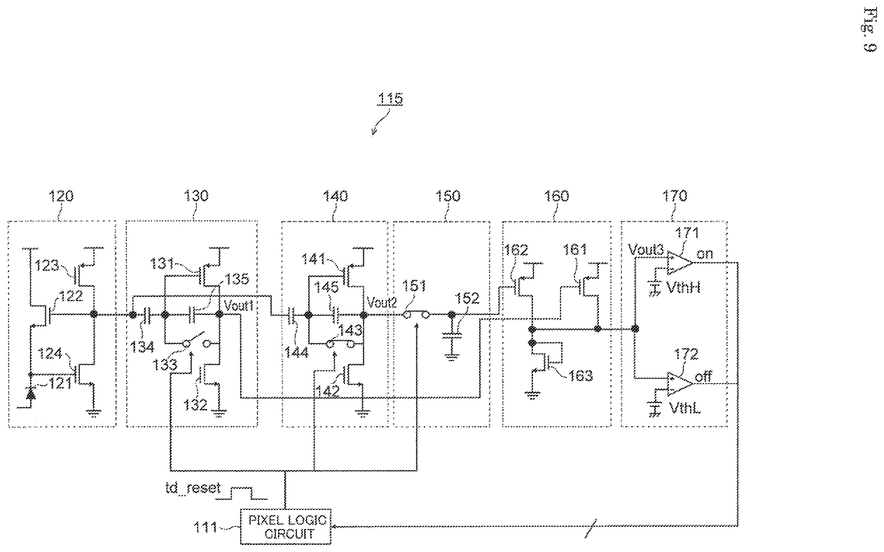

A fourth embodiment will be described below. The fourth embodiment is different from the first embodiment in the configuration of a photodetector circuit. Referring to FIG. 9, the photodetector circuit according to the fourth embodiment will be described below.

FIG. 9 illustrates the configuration of the photodetector circuit according to the fourth embodiment. The same constituent elements as those of the first embodiment are indicated by the same reference numerals, and detailed descriptions thereof are omitted. In a photodetector circuit 115 according to the present embodiment, a first switch 133 and a third switch 151 are P-type transistors as in the second embodiment, whereas a second switch 143 is an N-type transistor. Since the third switch 151 is always placed in an on state, a sampling hold circuit 150 is substantially inoperative as in the third embodiment.

Hence, as in the third embodiment, a luminance change of incident light in the photodetector circuit 115 according to the present embodiment is read by a first amplifier circuit 130 in a period P1 and a period P3 and is read by a second amplifier circuit 140 in a period P2.

Thus, also in the present embodiment, luminance changes of incident light are alternately read by the first amplifier circuit 130 and the second amplifier circuit 140 in a continuous manner, so that even if the function of the sampling hold circuit 150 is stopped, a rapid luminance change can be detected. The third switch 151 is always placed in an on-state to stop the function of the sampling hold circuit 150, thereby eliminating a reading error caused by channel charge injection of the sampling hold circuit 150.

Furthermore, an inverter 112 is not necessary in the present embodiment, thereby reducing the area of the photodetector circuit 115.

### Fifth Embodiment

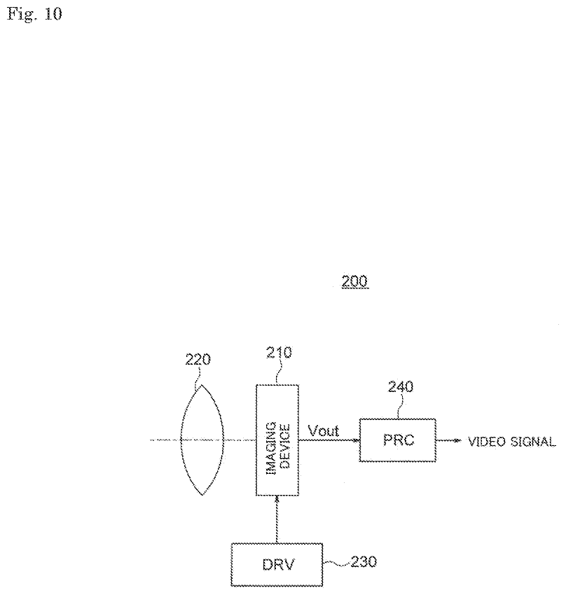

FIG. 10 illustrates an example of the configuration of 0 according to a fifth embodiment. An electronic device 200 according to the present embodiment is a camera system that includes an imaging device 210, a lens 220, a drive circuit (DRV) 230, and a signal processing circuit (PRC) 240 as illustrated in FIG. 10.

Any one of the imaging devices according to the first to fourth embodiments can be applied to the imaging device 210. The lens 220 forms an image of incident light (image light) on the imaging surface.

The drive circuit 230 includes a timing generator that generates various timing signals including a start pulse and a clock block for driving circuits in the imaging device 210 and drives the imaging device 210 in response to a predetermined timing signal.

The signal processing circuit 240 performs predetermined signal processing on the output signal of the imaging device 210. An image signal processed by the signal processing circuit 240 is recorded in, for example, a recording medium such as a memory. A hard copy of the image information recorded in the recording medium is made by a printer or the like. In addition, the image signal processed by the signal processing circuit 240 is displayed as a moving image on a monitor configured with a liquid crystal display or the like.

According to the present embodiment, a faster imaging function is achieved by installing the imaging devices according to the foregoing embodiments as the imaging device 210 in the electronic device 200, e.g., a digital still camera. This can detect, for example, high-speed vibrations of an object.

### <Example of Application to Moving Object>

The technique according to the present disclosure (the present technique) can be applied to various products. For example, the technique according to the present disclosure may be implemented as a device installed in any type of moving objects such as an automobile, an electric automobile, a hybrid electric automobile, a motorcycle, a bicycle, a personal mobility device, an airplane, a drone, a ship, and a robot.

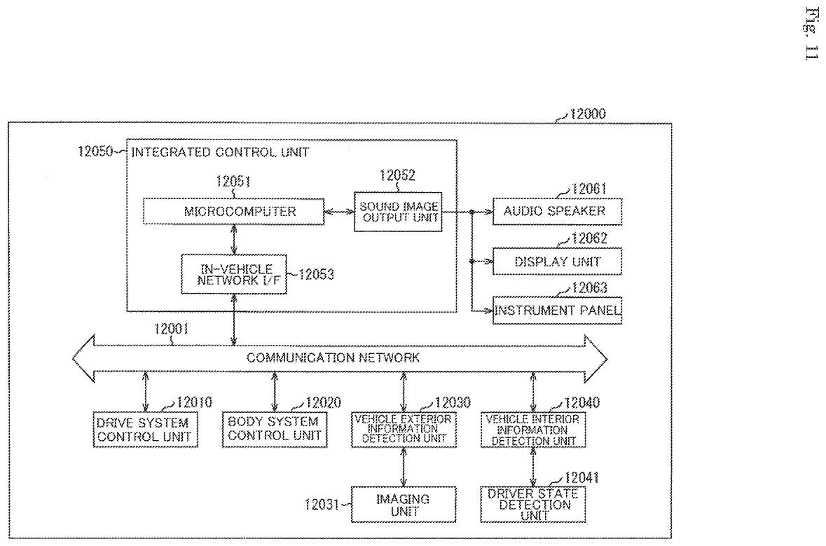

FIG. 11 is a block diagram illustrating a schematic configuration example of a vehicle control system, which is an example of a moving object control system to which the technique according to the present disclosure is applicable.

A vehicle control system 12000 includes a plurality of electronic control units connected via a communication network 12001. In the example illustrated in FIG. 11, the vehicle control system 12000 includes a drive system control unit 12010, a body system control unit 12020, a vehicle exterior information detection unit 12030, a vehicle interior information detection unit 12040, and an integrated control unit 12050. In addition, as the functional configuration of the integrated control unit 12050, a microcomputer 12051, a sound image output unit 12052, and an in-vehicle network I/F (Interface) 12053 are illustrated.

The drive system control unit 12010 controls a device operation related to the drive system of a vehicle according to various programs. For example, the drive system control unit 12010 functions as a control device for a driving force generation device that generates a vehicle driving force of an internal combustion engine, a driving motor, or the like, a driving force transmission mechanism that transmits a driving force to wheels, a steering mechanism that adjusts a steering angle of a vehicle, and a braking device that generates a braking force of the vehicle.

The body system control unit 12020 controls operations of various devices mounted in the vehicle body according to various programs. For example, the body system control unit 12020 functions as a control device of a keyless entry system, a smart key system, a power window device, or various lamps such as a headlamp, a back lamp, a brake lamp, a turn signal, and a fog lamp. In this case, radio waves transmitted from a portable device that substitutes for a key or signals of various switches may be inputted to the body system control unit 12020. The body system control unit 12020 receives inputs of the radio waves or signals and controls a door lock device, a power window device, and the lamps of the vehicle.

The vehicle exterior information detection unit 12030 detects information on the outside of the vehicle in which the vehicle control system 12000 is mounted. For example, an imaging unit 12031 is connected to the vehicle exterior information detection unit 12030. The vehicle exterior information detection unit 12030 causes the imaging unit 12031 to capture an image of the outside of the vehicle and receives the captured image. The vehicle exterior information detection unit 12030 may perform object detection processing or distance detection processing on persons, cars, obstacles, signs, and letters on the road on the basis of the received image.

The imaging unit 12031 is an optical sensor that receives light and outputs an electrical signal according to the amount of the received light. The imaging unit 12031 can also output the electrical signal as an image or distance measurement information. In addition, the light received by the imaging unit 12031 may be visible light or invisible light such as infrared light.

The vehicle interior information detection unit 12040 detects information on the inside of the vehicle. For example, a driver state detection unit 12041 that detects a state of a driver is connected to the vehicle interior information detection unit 12040. The driver state detection unit 12041 includes, for example, a camera that captures an image of a driver, and the vehicle interior information detection unit 12040 may calculate a degree of fatigue or concentration of the driver or may determine whether or not the driver is dozing on the basis of detection information inputted from the driver state detection unit 12041.

The microcomputer 12051 can calculate control target values for the driving force generation device, the steering mechanism, or the braking device on the basis of information on the inside and outside of the vehicle, the information being acquired by the vehicle exterior information detection unit 12030 or the vehicle interior information detection unit 12040, and the microcomputer 12051 can output control commands to the drive system control unit 12010. For example, the microcomputer 12051 can perform cooperative control for the purpose of implementing the functions of an ADAS (Advanced Driver Assistance System) including vehicle collision avoidance, impact mitigation, following traveling based on an inter-vehicle distance, vehicle speed maintenance driving, vehicle collision warning, and vehicle lane deviation warning.

Furthermore, the microcomputer 12051 can perform cooperative control for the purpose of automated driving or the like in which automated driving is performed without depending on operations by the driver, by controlling the driving force generator, the steering mechanism, or the braking device and the like on the basis of information about the surroundings of the vehicle, the information being acquired by the vehicle exterior information detection unit 12030 or the vehicle interior information detection unit 12040.

In addition, the microcomputer 12051 can output a control command to the body system control unit 12030 on the basis of the information on the outside of the vehicle, the information being acquired by the vehicle exterior information detection unit 12030. For example, the microcomputer 12051 can perform coordinated control for the purpose of antiglare, for example, switching of a high beam to a low beam by controlling a headlamp according to a position of a vehicle ahead or an oncoming vehicle detected by the vehicle exterior information detection unit 12030.

The sound image output unit 12052 transmits an output signal of at least one of a sound and an image to an output device capable of providing a notification of visual or auditory information to a passenger of the vehicle or the outside of the vehicle. In the example of FIG. 11, an audio speaker 12061, a display unit 12062, and an instrument panel 12063 are illustrated as output devices. The display unit 12062 may include, for example, at least one of an onboard display and a head-up display.

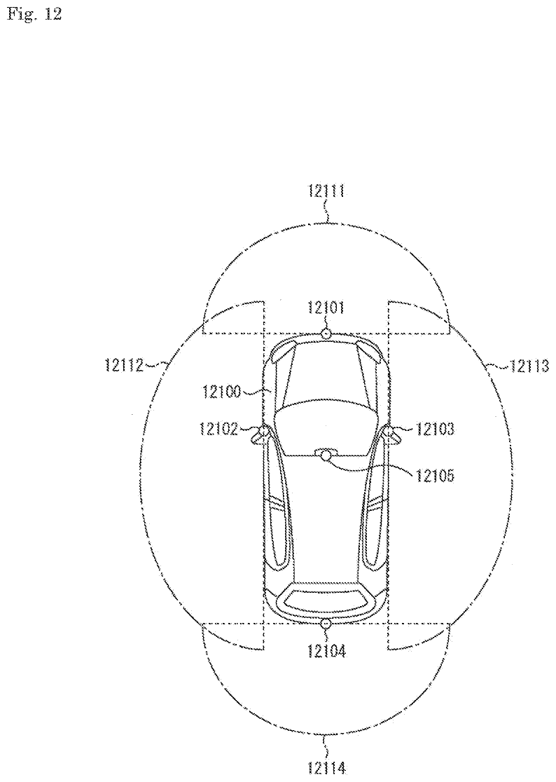

FIG. 12 illustrates an example of the installation position of the imaging unit 12031.

In FIG. 12, imaging units 12101, 12102, 12103, 12104, and 12105 are provided as the imaging unit 12031.

The imaging units 12101, 12102, 12103, 12104, and 12105 are provided at, for example, the positions of a front nose, side mirrors, a rear bumper, a back door, an internal upper portion of the front windshield of the vehicle 12100. The imaging unit 12101 provided at the front nose and the imaging unit 12105 provided at the internal upper portion of the front windshield mainly acquire images ahead of the vehicle 12100. The imaging units 12102 and 12103 provided at the side mirrors mainly acquire images on the sides of the vehicle 12100. The imaging unit 12104 provided at the rear bumper or the back door mainly acquires an image behind the vehicle 12100. The imaging unit 12105 provided in the internal upper portion of the front windshield is mainly used to detect a vehicle ahead, a pedestrian, an obstacle, a traffic signal, a traffic sign, or a lane.

FIG. 12 illustrates an example of the imaging ranges of the imaging units 12101 to 12104. An imaging range 12111 indicates the imaging range of the imaging unit 12101 provided at the front nose, an imaging range 1211212113 indicating the imaging ranges of the imaging units 12102 and 12103 provided at the side mirrors, and an imaging range 12114 indicates the imaging range of the imaging unit 12104 provided at the rear bumper or the back door. For example, a bird's-eye view image of the vehicle 12100 as viewed from above can be obtained by superimposing pieces of image data captured by the imaging units 12101 to 12104.

At least one of the imaging units 12101 to 12104 may have the function of obtaining distance information. For example, at least one of the imaging units 12101 to 12104 may be a stereo camera including a plurality of imaging elements or may be an imaging element that has pixels for phase difference detection.

For example, the microcomputer 12051 can extract, in particular, a closest three-dimensional object that is located on a traveling path of the vehicle 12100 and travels at a predetermined speed (for example, 0 km/h or higher) in the substantially same direction as the vehicle 12100, as a vehicle ahead of the vehicle 12100 by acquiring a distance to each three-dimensional object in the imaging ranges 12111 to 12114 and a temporal change within the distance (a relative speed with respect to the vehicle 12100) on the basis of distance information obtained from the imaging units 12101 to 12104. The microcomputer 12051 can also set an inter-vehicle distance to be secured from the vehicle ahead and perform automatic brake control (including following stop control) and automatic acceleration control (including following start control). Thus, cooperative control can be performed for the purpose of, for example, automated driving in which the vehicle travels in an automated manner without depending on operations by the driver.

For example, the microcomputer 12051 can extract three-dimensional object data about three-dimensional objects after classifying the data into two-wheeled vehicles, normal vehicles, large vehicles, pedestrians, and other three-dimensional objects such as electric poles on the basis of distance information obtained from the imaging units 12101 to 12104, and use the three-dimensional object data for automated avoidance of obstacles. The microcomputer 12051 classifies, for example, obstacles around the vehicle 12100 into obstacles visually identifiable by the driver of the vehicle 12100 and obstacles that are difficult to visually identify. The microcomputer 12051 then determines a collision risk indicating the degree of risk of collision with each obstacle. If a collision is likely to occur while the collision risk is equal to or higher than a set value, an alarm is outputted to the driver through the audio speaker 12061 or the display unit 12062 or forced deceleration or avoidance steering is performed through the drive system control unit 12010, thereby providing driver assistance for collision avoidance.

At least one of the imaging units 12101 to 12104 may be an infrared camera that detects infrared rays. For example, the microcomputer 12051 can recognize a pedestrian by determining the presence or absence of a pedestrian in the captured image of the imaging units 12101 to 12104. A pedestrian is recognized by, for example, a procedure to extract feature points in the captured images of the imaging units 12101 to 12104 that are infrared cameras and a procedure to determine whether an object is a pedestrian or not by performing pattern matching on a series of feature points indicating an outline of the object. When the microcomputer 12051 determines that a pedestrian is present in the captured images of the imaging unit 12101 to 12104 and recognizes the pedestrian, the sound image output unit 12052 controls the display unit 12062 such that a square border line for emphasis is superimposed on the recognized pedestrian. Moreover, the sound image output unit 12052 may control the display unit 12062 such that an icon or the like indicating the pedestrian is displayed at a desired position.

An example of the vehicle control system to which the technique according to the present disclosure is applicable was described above. The technique according to the present disclosure is applicable to, for example, the imaging unit 12031 among the configurations described above. Specifically, the imaging devices according to the first to fourth embodiments can be applied to the imaging unit 12031. By applying the technique according to the present disclosure, a captured image can be quickly obtained and thus the image quality can be improved.

The present technique can be configured as follows:

(1) An imaging device including: a photoelectric conversion circuit that generates a pixel signal corresponding to a luminance of incident light; and

a reading circuit that reads the pixel signal from the photoelectric conversion circuit,

wherein the reading circuit includes:

a first amplifier circuit that reads the pixel signal in a first period;

a second amplifier circuit that reads the pixel signal in a second period subsequent to the first period;

an adding circuit that adds a first output signal of the first amplifier circuit and a second output signal of the second amplifier circuit; and

a comparator circuit that detects a change of the luminance on the basis of a third output signal of the adding circuit.

(2) The imaging device according to (1), wherein the reading circuit is disposed between the second amplifier circuit and the adding circuit and further includes a sampling hold circuit that temporarily holds the second output signal.

(3) The imaging device according to (2), wherein the second amplifier circuit has a circuit configuration identical to the circuit configuration of the first amplifier circuit.

(4) The imaging device according to (3), wherein the first amplifier circuit includes a first P-type transistor, a first N-type transistor connected in series with the first P-type transistor, and a first switch disposed between the gate of the first P-type transistor and the source of the first P-type transistor, the second amplifier circuit may include a second P-type transistor, a second N-type transistor connected in series with the second P-type transistor, and a second switch disposed between the gate of the second P-type transistor and the source of the second P-type transistor,

in the first period, the first switch may be placed in an off-state and the second switch may be placed in an on-state, and

in the second period, the first switch is placed in an on-state and the second switch is placed in an off-state.

(5) The imaging device according to (4), wherein the sampling hold circuit includes a third switch disposed between the second amplifier circuit and the adding circuit, and a capacitor with one end connected to the third switch and the adding circuit and the grounded other end, and

the third switch is placed in an off-state in the first period and is placed in an on-state in the second period.

(6) The imaging device according to any one of (1) to (5), further including a pixel array part including a plurality of pixels arranged in a two-dimensional array,

wherein each of the plurality of pixels includes the photoelectric conversion circuit and the reading circuit.

(7) The imaging device according to (5), wherein the imaging device is configured with a P-type transistor or an N-type transistor that is driven on the basis of a reset signal with a signal level changing at the timing of switching of the first switch, the second switch, and the third switch from the first period to the second period.

(8) The imaging device according to (7), wherein the first switch, the second switch, and the third switch are each configured with a third P-type transistor, and

the imaging device further includes an inverter that inverts the signal level of the reset signal inputted to the second switch.

(9) The imaging device according to (7), wherein the first switch and the third switch are each configured with a third P-type transistor, and

the second switch is configured with a third N-type transistor.

(10) The imaging device according to (5), wherein the sampling hold circuit includes a third switch disposed between the second amplifier circuit and the adding circuit, and a capacitor with one end connected to the third switch and the adding circuit and the grounded other end, and

the third switch is placed in an on-state in the first period and the second period.

(11) The imaging device according to (7), further including a pixel logic circuit that drives the photoelectric conversion circuit and the reading circuit.

(12) The imaging device according to (11), wherein the pixel logic circuit generates the reset signal.

(13) The imaging device according to any one of (1) to (9), wherein the second period is the reset period of the first amplifier circuit, and the length of the reset period is fixed.

(14) The imaging device according to (10), wherein the second period has a length that is variable according to the detection result of the comparator circuit.

(15) The imaging device according to any one of (1) to (14), wherein the comparator circuit includes:

a first comparator that outputs the result of a comparison of the third output signal with a predetermined upper-limit threshold value; and

a second comparator that outputs the result of a comparison of the third output signal with a predetermined lower-limit threshold value.

(16) An electronic device including an imaging device including: a photoelectric conversion circuit that generates a pixel signal corresponding to a luminance of incident light; a first amplifier circuit that reads the pixel signal in a first period;

a second amplifier circuit that reads the pixel signal in a second period subsequent to the first period; an adding circuit that adds a first output signal of the first amplifier circuit and a second output signal of the second amplifier circuit; and a comparator circuit that detects a change of the luminance on the basis of a third output signal of the adding circuit.

(17) A light detecting method including: generating a pixel signal corresponding to a luminance of incident light;

reading the pixel signal in a first period by a first amplifier circuit;

reading the pixel signal in a second period subsequent to the first period by a second amplifier circuit different from the first amplifier circuit;

adding a first output signal of the first amplifier circuit and a second output signal of the second amplifier circuit by an adding circuit; and

detecting a change of the luminance on the basis of a third output signal of the adding circuit.

### REFERENCE SIGNS LIST

1 Imaging device
11 Pixel
110, 113 to 115 Photodetector circuit
111 Pixel logic circuit
112 Inverter
120 Photoelectric conversion circuit
130 First amplifier circuit
131 First P-type transistor
132 First N-type transistor
133 First switch
140 Second amplifier circuit
141 Second P-type transistor
142 Second N-type transistor
143 Second switch
150 Sampling hold circuit
151 Third switch
152 Capacitor
160 Adding circuit
170 Comparator circuit
171 First comparator
172 Second comparator

1. An imaging device comprising: a photoelectric conversion circuit that generates a pixel signal corresponding to a luminance of incident light; and
a reading circuit that reads the pixel signal from the photoelectric conversion circuit,
wherein the reading circuit includes:
a first amplifier circuit that reads the pixel signal in a first period;
a second amplifier circuit that reads the pixel signal in a second period subsequent to the first period;
an adding circuit that adds a first output signal of the first amplifier circuit and a second output signal of the second amplifier circuit; and
a comparator circuit that detects a change of the luminance on a basis of a third output signal of the adding circuit.

2. The imaging device according to claim 1, wherein the reading circuit is disposed between the second amplifier circuit and the adding circuit and further includes a sampling hold circuit that temporarily holds the second output signal.

3. The imaging device according to claim 2, wherein the second amplifier circuit has a circuit configuration identical to a circuit configuration of the first amplifier circuit.

4. The imaging device according to claim 3, wherein the first amplifier circuit includes a first P-type transistor, a first N-type transistor connected in series with the first P-type transistor, and a first switch disposed between a gate of the first P-type transistor and a source of the first P-type transistor,
the second amplifier circuit includes a second P-type transistor, a second N-type transistor connected in series with the second P-type transistor, and a second switch disposed between a gate of the second P-type transistor and a source of the second P-type transistor,
in the first period, the first switch is placed in an off-state and the second switch is placed in an on-state, and
in the second period, the first switch is placed in an on-state and the second switch is placed in an off-state.

5. The imaging device according to claim 4, wherein the sampling hold circuit includes a third switch disposed between the second amplifier circuit and the adding circuit, and a capacitor with one end connected to the third switch and the adding circuit and the grounded other end, and
the third switch is placed in an off-state in the first period and is placed in an on-state in the second period.

6. The imaging device according to claim 1, further comprising a pixel array part including a plurality of pixels arranged in a two-dimensional array,
wherein each of the plurality of pixels includes the photoelectric conversion circuit and the reading circuit.

7. The imaging device according to claim 5, wherein the imaging device is configured with a P-type transistor or an N-type transistor that is driven on a basis of a reset signal with a signal level changing at timing of switching of the first switch, the second switch, and the third switch from the first period to the second period.

8. The imaging device according to claim 7, wherein the first switch, the second switch, and the third switch are each configured with a third P-type transistor, and
the imaging device further includes an inverter that inverts the signal level of the reset signal inputted to the second switch.

9. The imaging device according to claim 7, wherein the first switch and the third switch are each configured with a third P-type transistor, and
the second switch is configured with a third N-type transistor.

10. The imaging device according to claim 5, wherein the sampling hold circuit includes a third switch disposed between the second amplifier circuit and the adding circuit, and a capacitor with one end connected to the third switch and the adding circuit and the grounded other end, and
the third switch is placed in an on-state in the first period and the second period.

11. The imaging device according to claim 7, further comprising a pixel logic circuit that drives the photoelectric conversion circuit and the reading circuit.

12. The imaging device according to claim 11, wherein the pixel logic circuit generates the reset signal.

13. The imaging device according to according to claim 1, wherein the second period is a reset period of the first amplifier circuit, and a length of the reset period is fixed.

14. The imaging device according to claim 10, wherein the second period has a length that is variable according to the detection result of the comparator circuit.

15. The imaging device according to claim 1, wherein the comparator circuit includes:
a first comparator that outputs a result of a comparison of the third output signal with a predetermined upper limit threshold value; and
a second comparator that outputs a result of a comparison of the third output signal with a predetermined lower-limit threshold value.

16. An electronic device comprising an imaging device including: a photoelectric conversion circuit that generates a pixel signal corresponding to a luminance of incident light; a first amplifier circuit that reads the pixel signal in a first period; a second amplifier circuit that reads the pixel signal in a second period subsequent to the first period; an adding circuit that adds a first output signal of the first amplifier circuit and a second output signal of the second amplifier circuit; and a comparator circuit that detects a change of the luminance on a basis of a third output signal of the adding circuit.

17. A light detecting method comprising: generating a pixel signal corresponding to a luminance of incident light;
reading the pixel signal in a first period by a first amplifier circuit;
reading the pixel signal in a second period subsequent to the first period by a second amplifier circuit different from the first amplifier circuit;
adding a first output signal of the first amplifier circuit and a second output signal of the second amplifier circuit by an adding circuit; and
detecting a change of the luminance on a basis of a third output signal of the adding circuit.
